(19) United States
(12) Patent Application Publication
(10) Pub. No.: US 2002/0165116 A1
(43) Pub. Date: Nov. 7, 2002

(54) Alkaline washing liquid for automated clinical analyzer

(76) Inventors: Toshihiro Ono, Tokyo (JP); Yasuyuki Konishi, Kanagawa (JP); Yasutoshi Kashiwagi, Tokyo (JP)

Correspondence Address: John R. Van Amsterdam, Wolf, Greenfield & Sacks, P.C., Federal Reserve Plaza, 600 Atlantic Avenue, Boston, MA, 02210, US

(21) Appl. No.: 10/128,146

(22) Filed: Apr. 23, 2002

(30) Foreign Application Priority Data
Apr. 25, 2001 (JP) 2001-128233

(51) Int. Cl. C11D 17/00

(52) U.S. Cl. 510/421; 510/506

(57) ABSTRACT

An alkaline washing liquid for an automated clinical analyzer is provided that allows measurement to be carried out with higher accuracy when simultaneously analyzing multiple items by preventing abnormal measurement due to reagent migration from other items, etc. A production process for the washing liquid and a washing method using it are also provided. The washing liquid has a cloud point of 36° C. to 50° C. and is formed from at least two kinds of polyoxyethylene alkyl ether type nonionic surfactants having different cloud points.

### TECHNICAL FIELD

The present invention relates to an alkaline washing liquid for avoiding cross-contamination of reagents used in an automated clinical analyzer, or for avoiding the adsorption of latex particles on a reaction cell, the use thereof, and a process for the production thereof.

### BACKGROUND ART

Clinical testing in recent years has been treating a large number of measurement items, and as a result the reaction principles involved therein cover a wide range including enzyme reactions, chemical reactions, and immunoreactions. An automated clinical analyzer is therefore required to simultaneously analyze measurement items employing this wide variety of principles. In such cases, however, there is a serious problem of interference between different reagents, which causes abnormalities in the measurement when a reagent is poured into a reaction cell, when a treatment is carried out in a reaction cell for another measurement item after completion of a reaction, etc. In order to exclude the influence of such interference between reagents, an alkaline washing liquid or an alkaline washing liquid containing a surfactant is used. However, the conventional washing liquids do not always exhibit an adequate washing effect, and as a result problems often arise.

Japanese Patent Application No. 11-49737 discloses an alkaline washing liquid containing a surfactant such as a polyoxyalkylene alkylether type nonionic surfactant. However, this washing liquid is used only for washing with the purpose of removing fine particles such as polystyrene latex and, in particular, magnetic polystyrene latex, and is therefore not necessarily suitable for the removal of an extremely wide variety of contaminants.

That is, there is still a large demand for a washing liquid that can be used in an automated clinical analyzer and has a higher washing effect.

### DISCLOSURE OF INVENTION

An object of the present invention is to provide a washing liquid that allows measurement to be carried out with higher accuracy when simultaneously analyzing multiple items using an automated clinical analyzer by preventing abnormal measurement due to reagent migration from other items, etc., a production process therefore, and a washing method using same. A particular object of the present invention is to provide a washing liquid having a high washing effect for latex particles in a measurement reagent, a production process therefore, and a washing method using same.

As a result of an intensive investigation by the present inventors in order to accomplish the above-mentioned objects, it was found that the washing effect of a washing liquid can be outstandingly enhanced by preparing a specific nonionic surfactant under specific conditions, and the present invention has thus been achieved.

That is, the present invention relates to an alkaline washing liquid for an automated clinical analyzer, the alkaline washing liquid including a polyoxyethylene alkyl ether type nonionic surfactant and having a cloud point of 36° C. to 50° C.

Furthermore, the present invention relates to the aforementioned alkaline washing liquid wherein it includes at least two kinds of polyoxyethylene alkyl ether type nonionic surfactants having different numbers of carbons in their alkyl chains.

Moreover, the present invention relates to the aforementioned. alkaline washing liquid wherein the content of each of the polyoxyethylene alkyl ether type nonionic surfactants is 5 to 95 wt % of the total nonionic surfactants.

Furthermore, the present invention relates to the aforementioned alkaline washing liquid wherein it includes a cationic surfactant.

Moreover, the present invention relates to the aforementioned alkaline washing liquid wherein it includes a chelating agent.

Furthermore, the present invention relates to the aforementioned alkaline washing liquid wherein the automated clinical analyzer is an automated biochemical analyzer.

Moreover, the present invention relates to use of the aforementioned alkaline washing liquid in washing a reaction cell and a reagent dispensing pipette for an automated clinical analyzer.

Furthermore, the present invention relates to the aforementioned use wherein the washing temperature is 36° C. to 46° C.

Moreover, the present invention relates to the aforementioned use wherein the automated clinical analyzer is an automated biochemical analyzer.

Furthermore, the present invention relates to a process for producing an alkaline washing liquid for an automated clinical analyzer according to the intended washing temperature by including at least two kinds of polyoxyethylene alkyl ether type nonionic surfactants having different numbers of carbons in their alkyl chains.

Moreover, the present invention relates to the aforementioned process wherein the alkaline washing liquid for an automated clinical analyzer has a cloud point of 36° C. to 50° C.

Furthermore, the present invention relates to the aforementioned process wherein a cationic surfactant is further included.

It is known that the surface activity of a nonionic surfactant peaks at a temperature that is slightly lower than its cloud point (e.g. ‘Kaimenkasseizai Handbook (Surfactant Handbook)’, p. 24 to p. 25). The use of a nonionic surfactant having a cloud point around the washing temperature generally used in the measurement of biochemical items can therefore be considered as a means of enhancing the washing effect of a washing liquid. However, this idea has never been applied to a washing liquid for an automated clinical analyzer. Although the reason therefor is not clear, it can be surmised that the washing temperature generally used in the measurement of biochemical items is often as low as 30° C. to 46° C. and, in particular, about 37° C., and a washing liquid to which a nonionic surfactant having such a low cloud point is added cannot be considered to be at all practical in terms of its ease of clouding, etc. due to its low cloud point, and it can also be surmised that up to this time the washing liquids for automated clinical analyzers have not been required to have a particularly high washing effect. Under such circumstances, even if a nonionic surfactant is used in a conventional alkaline washing liquid for biochemical item measurement, only those having a high cloud point are used, and their washing effects are not always satisfactory.

However, it has been found that using, as a component of the washing liquid, a polyoxyethylene alkyl ether type nonionic surfactant whose cloud point has been adjusted to 36° C. to 50° C. surprisingly enhances the washing effect to an outstanding extent, and there are no particular problems in terms of handling. For example, in accordance with the washing liquid of the present invention, its excellent washing effect allows measurement to be continued with little adsorption of a reagent component even after 40,000 repetitions of measurement. This washing liquid is incomparably superior to conventional washing liquids. Moreover, the nonionic surfactant content in the washing liquid of the present invention can be set within a very wide range of 5 to 95 wt % of the total nonionic surfactants. The present invention can therefore easily achieve a desired washing power by an extremely simple and precise adjustment of the cloud point of the washing liquid by adding at least two kinds of nonionic surfactants having different numbers of carbons in their alkyl chains according to the intended purpose, that is, according to conditions such as the type of the sample, the measurement item, and the washing temperature.

The washing liquid of the present invention can contain a cationic surfactant for the purpose of adjusting the cloud point without impairing the washing effect. The additional use of a cationic surfactant in this way allows the cloud point of the washing liquid to be adjusted yet more easily and precisely.

Moreover, in order to prevent a metal from being carried over from one measurement item system to another among various biochemical measurement items, the washing liquid of the present invention can contain a chelating agent corresponding to the metal, thus heightening the effect.

### BRIEF DESCRIPTION OF DRAWINGS

In the drawings:

FIG. 1 is a graph showing the relationship between surfactant concentration and cloud point.

FIG. 2 is a graph showing the effect of Determiner Auto washing agent on fluctuations in measured values due to the attachment of latex particles.

FIG. 3 is a graph showing the effect of Yuai BM3 on fluctuations in measured values due to the attachment of. latex particles.

FIG. 4 is a graph showing the effect of the washing liquid of the present invention on fluctuations in measured values due to the attachment of latex particles.

### MODES FOR CARRYING OUT THE INVENTION

The washing liquid of the present invention contains at least two kinds of specific surfactants, has its cloud point adjusted at 36° C. to 50° C., and may contain a chelating agent for washing a specific metal. Examples of the polyoxyethylene alkyl ether type nonionic surfactant used include a polyoxyethylene alkyl ether system having an HLB value of 6 to 20 and represented by the general formula R—O—(CH₂CH₂O)ₙ—H(R═C₁₀₋₁₈H₂₁₋₃₇). This type of surfactant is commercially available as, for example, NIKKOL BT-3, NIKKOL BT-5, NIKKOL BT-7, NIKKOL BT-9 and NIKKOL BT-12 (all manufactured by Nikko Chemicals Co., Ltd.), which have a straight-chain higher secondary alcohol as a lipophilic group.

With regard to the cationic surfactant for fine adjustment of the cloud point, a benzalkonium chloride can be used. With regard to the chelating agent that is added to wash a specific metal, disodium ethylenediaminetetraacetate, dipotassium ethylenediaminetetraacetate, etc. can be cited.

When two kinds of nonionic surfactants are used, the mixing ratio thereof is usually 0.5:9.5 to 9.5:0.5 on a weight basis, and preferably 1:16 to 1:3. The nonionic surfactant concentration in the washing liquid is usually 0.01 to 5 wt %, and preferably 0.02 to 2 wt. %.

For the purpose of finely adjusting the cloud point, three or more types of surfactants may be mixed. The concentration of chelating agent for washing a metal is usually 5 mmol/L to 50 mmol/L, and preferably 7 mmol/L to 20 mmol/L.

The cloud point of a surfactant is generally proportional to the number of carbons therein. The cloud point of the washing liquid of the present invention can therefore be adjusted by mixing surfactants having different numbers of carbons.

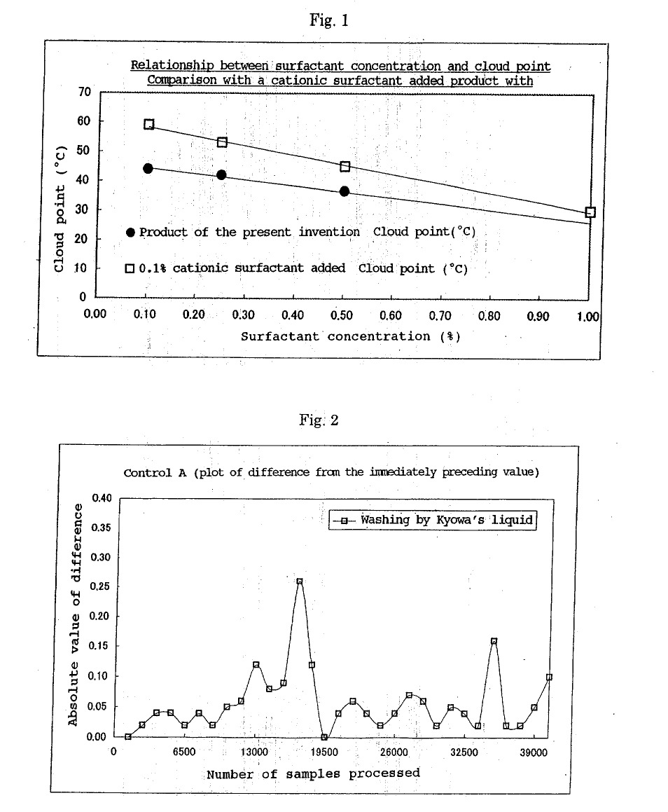

For example, the relationship between the surfactant concentration and the cloud point when mixing two or more types of surfactants is shown in FIG. 1.

Next, a mode for using the washing liquid of the present invention in an automated clinical analyzer is described.

Measurement using the automated clinical analyzer is carried out according to, for example, the following procedure:

(Step 1) a predetermined amount of analysis reagent 1 is dispensed into a reaction cell using a reagent dispensing pipette;

(Step 2) a predetermined amount of a sample is then dispensed into the reaction cell charged with analysis reagent 1, using a sample dispensing pipette;

(Step 3) after a fixed time, a predetermined amount of analysis reagent 2 is dispensed into the reaction cell charged with the sample and analysis reagent 1, using the reagent dispensing pipette;

(Step 4) the absorbance is measured for a designated time;

(Step 5) after completion of the analysis, the sample and the reagents are discharged from the reaction cell and washing is carried out for the next analysis.

Since the above-mentioned procedure is carried out repetitively and continuously, the reagent dispensing pipette and the reaction cell are used repeatedly for analyses based on a variety of reaction principles.

In the case where a reaction cell is washed after completion of an analysis, the washing liquid of the present invention is dispensed into the reaction cell via a special washing liquid dispensing nozzle from a designated washing liquid bottle disposed inside the analyzer, and discharged after a fixed time. In the case of washing a reagent dispensing pipette, a fixed amount of the washing liquid of the present invention is aspirated into the pipette from a washing liquid bottle set at a designated position, and discharged afterward together with purified water. These operations can wash away interfering components attached to the reagent pipette, the reaction cell, and a liquid waste aspiration line. Furthermore, the sample dispensing pipette can also be washed by similar operations.

### EXAMPLES

The present invention is explained in further detail by reference to examples below, but the present invention is in no way limited thereby.

In the examples below, a BioMajesty JCA-BM 1650 fully automated clinical analyzer (manufactured by JEOL Ltd.) was used as an automated clinical analyzer.

### Example 1

As measurement items for confirming cross-contamination of reagents, a combination of the cholesterol measurement reagent Cica Liquid CHO (manufactured by Kanto Kagaku Kabushiki Kaisha) as an item that would contaminate, and the lipase measurement reagent Nescoat Lipase (manufactured by Azwell Inc.) as an item that would be contaminated was chosen. The effect on these reagents of washing a reaction cell was compared for a) a washing liquid containing 1N—NaOH and a surfactant (trade name HiAlkali D; manufactured by Hitachi, Ltd.), b) a washing liquid containing 1N—NaOH alone (trade name Cellclean BM1; manufactured by JEOL Ltd.), and c) a product of the present invention.

As the product of the present invention, a 1.0N aqueous solution of sodium hydroxide was prepared using purified water and mixed with, as surfactants, (1) 0.9 wt % of a polyoxyethylene alkyl ether type nonionic surfactant (n=9, HLB value=13.5) (trade name NIKKOL BT-9; manufactured by Nikko Chemicals Co., Ltd.) and (2) 0.06 wt % of a polyoxyethylene alkyl ether type nonionic surfactant (n=5, HLB value=10.5) (trade name, NIKKOL BT-5; manufactured by Nikko Chemicals Co., Ltd.). In the actual washing operation, the alkaline washing liquid of the present invention was automatically diluted 10 times with purified water within the above-mentioned automated clinical analyzer, and the diluted liquid was used for washing the reaction cell. The cloud point of the washing liquid so diluted within the analyzer should be 44° C. (see FIG. 1).

A measured value obtained by single item analysis was used as the standard value, and the divergence between the standard value and a measured value obtained by simultaneous analysis was calculated using the equation (I) below and defined as the contamination level (%):

Contamination level(%)=value measured in simultaneous analysis/standard value×100 (I)

That is, when there is no contamination after washing, the level is to be 100%. The standard value for lipase was 12 units/L. A measurement was carried out by setting each of the washing liquids that were to be compared in a reaction cell washing bottle of the analyzer, washing the reaction cell that had been used for the analysis of cholesterol by a normal analyzer washing operation, and then measuring the lipase level.

The resulting levels of contamination for each of the washing liquids tested were 133% for a) HiAlkali D, 142% for b) Cellclean BM1, and 100% for c) the product of the present invention. The washing power of the product of the present invention was thus apparently higher than that of the conventional products.

### Example 2

As an example of the effect of preventing adsorption on a cell, the effect on fluctuations in the measured value caused by adsorption on the cell of latex particles used for the measurement of hemoglobin Alc fraction, etc. when the washing was carried out using commercial washing liquids and when using a product of the present invention were compared. The commercial washing liquids for an automated clinical analyzer used as controls were a) washing liquid (1) containing 1N—NaOH and a surfactant (trade name Determiner Auto; manufactured by Kyowa Medics) and b) washing liquid (2) containing 1N—NaOH and a surfactant (trade name White Alkali BM3; manufactured by Yuai Chemicals, and c) a product of the present invention (the same composition as in Example 1) was used.

As a test reagent, Determiner HbAlc (manufactured by Kyowa Medics) was used, and approximately 40,000 human erythrocyte samples were analyzed continuously while measuring a control sample for checking the measured values in every 1,300 samples.

When latex particles in the reagent were adsorbed on the reaction cell, the measured value for the control sample fluctuated. The washing effect among the washing liquids was therefore compared by looking at the difference between the fluctuation and the immediately preceding measured value of the control.

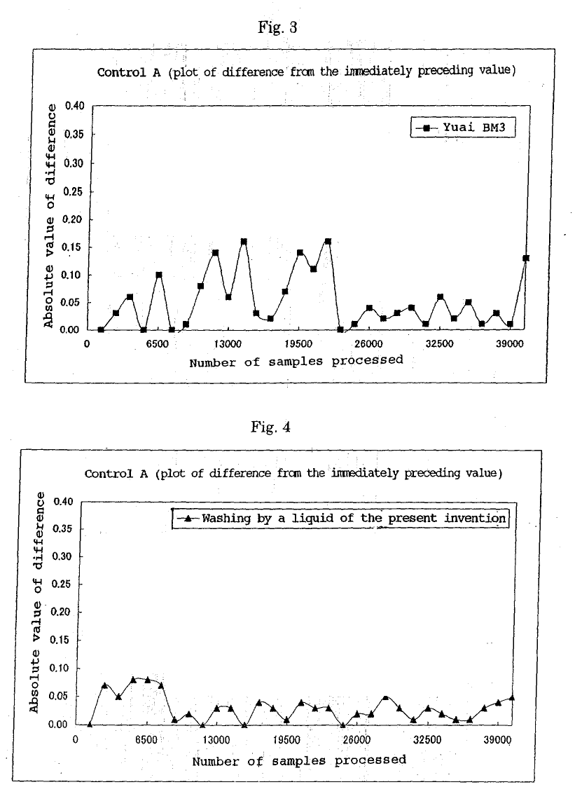

As the results, as shown in FIGS. 2 to 4, the product of the present invention effectively and clearly suppressed the adsorption of latex particles on the reaction cell in comparison with the other commercial automated clinical analyzer washing liquids. That is, it was revealed that the product of the present invention is also highly effective in washing latex particles adsorbed on the reaction cell.

### Example 3

As an example of the effect of avoiding cross-contamination of reagents containing metals, the effect in the measurement of 1,5-anhydroglucitol (1.5AG) immediately after using a measurement reagent for the phosphomolybdic acid method, which is one of the inorganic phosphorus measurement methods, was examined. In this system, cross-contamination of the reagents was to decrease the measured value.

Autosera IP (manufactured by Daiichi Pure Chemicals Co., Ltd.) was used as the reagent for the measurement of inorganic phosphorus, and Lana 1.5AG Auto (manufactured by Kainos Laboratories, Inc.) was used as the reagent for 1.5AG measurement. As commercial washing liquids for comparison a) HiAlkali D and b) Cellclean BM1, and c) a product of the present invention (the alkaline washing liquid of the present invention as in Example 1 with 70 mmol/l (weight/volume) disodium ethylenediaminetetraacetate added) were used.

A measured value obtained by a single item analysis was used as the standard value, and the separation between the standard value and a measured value obtained by simultaneous analysis was calculated using the above-mentioned equation (I) and defined as the contamination level.

The standard value for 1.5AG was 22 μg/ml.

Each of the washing liquids was set in a reaction cell washing bottle fixed in the analyzer, the reaction cell used for analysis of inorganic phosphorus was washed by the normal washing operations of the analyzer, and 1.5AG was then measured.

The resulting level of contamination for each of the commercial washing liquids was 27% for a) HiAlkali D and 93% for b) Cellclean BM1, whereas c) the product of the present invention gave a level of 100%. That is, it was revealed that the washing liquid of the present invention containing a corresponding chelating agent has both a higher washing effect in avoiding cross-contamination of specific reagents and a higher effect in avoiding cross-contamination of metal reagents in comparison with the conventional products.

Effect of the Invention

Automated clinical analyzers have experienced advances in the speed of reporting measurement results and a saving in labor; these trends will continue and simultaneous use of analytical reagents employing a greater variety of reaction principles will become inevitable. Under these circumstances, the use of the alkaline washing liquid of the present invention prevents cross-contamination of reagents and degradation of the reaction cell due to adsorption of latex particles, and thereby achieves enhancing the accuracy and precision of the measured values.

What is claimed is:

1. An alkaline washing liquid for an automated clinical analyzer, comprising:
a polyoxyethylene alkyl ether type nonionic surfactant, said alkaline washing liquid having a cloud point of 36° C. to 50° C.

2. The alkaline washing liquid according to claim 1 wherein it comprises at least two kinds of polyoxyethylene alkyl ether type nonionic surfactants having different. numbers of carbons in their alkyl chains.

3. The alkaline washing liquid according to claim 2 wherein the content of each of the polyoxyethylene alkyl ether type nonionic surfactants is 5 to 95 wt % of the total nonionic surfactants.

4. The alkaline washing liquid according to claim 1 wherein it further comprises a cationic surfactant.

5. The alkaline washing liquid according to claim 1 wherein it further comprises a chelating agent.

6. The alkaline washing liquid according to claim 1 wherein the automated clinical analyzer is an automated biochemical analyzer.

7. Use of the alkaline washing liquid according to claim 1 in washing a reaction cell and a reagent dispensing pipette for an automated clinical analyzer.

8. The use according to claim 7 wherein the washing temperature is 36° C. to 46° C.

9. The use according to claim 7 wherein the automated clinical analyzer is an automated biochemical analyzer.

10. A process for producing an alkaline washing liquid for an automated clinical analyzer according to the intended washing temperature, comprising:
including at least two kinds of polyoxyethylene alkyl ether type nonionic surfactants having different numbers of carbons in their alkyl chains.

11. The process according to claim 10 wherein the alkaline washing liquid for an automated clinical analyzer has a cloud point of 36° C. to 50° C.

12. The process according to claim 10 wherein it further comprises including a cationic surfactant.
